(19) United States
(12) Patent Application Publication
(10) Pub. No.: US 2025/0188679 A1
(43) Pub. Date: Jun. 12, 2025

(54) STARCH-CELLULOSE COMPOSITE MATERIAL

(71) Applicant: Pratt Corrugated Holdings, Inc., Brookhaven, GA (US)

(72) Inventors: John Anagnostopoulos, Atlanta, GA (US); Greg Sollie, Sharpsburg, GA (US); Jamie Waltermire, Peachtree City, GA (US); Shifeng Chen, Newport News, VA (US)

(21) Appl. No.: 19/056,573

(22) Filed: Feb. 18, 2025

Related U.S. Application Data
(63) Continuation of application No. 17/666,206, filed on Feb. 7, 2022, now Pat. No. 12,270,153.
(60) Provisional application No. 63/148,474, filed on Feb. 11, 2021.

(51) Int. Cl. D21F 11/00; B29B 7/90; B29C 69/00; B29K 105/04; B29K 201/00; D21H 17/00; D21H 17/09; D21H 17/15; D21H 17/22; D21H 17/26; D21H 17/28; D21H 17/31; D21H 17/36; D21H 17/66; D21H 21/08; D21H 23/64

(52) U.S. Cl. CPC D21F 11/002; B29B 7/90; B29C 69/001; D21H 17/09; D21H 17/15; D21H 17/22; D21H 17/26; D21H 17/28; D21H 17/31; D21H 17/36; D21H 17/66; D21H 17/74; D21H 21/08; D21H 23/64; B29K 2105/04; B29K 2201/00

(57) ABSTRACT

A composite can include cellulose fiber and foam binding the cellulose fiber. A method for manufacturing a composite can comprise mixing a plurality of ingredients to form a pre-foam mixture, foaming the pre-foam mixture to produce a foam, mixing the foam with cellulose fiber to form a composite material, and curing the composite material.

### CROSS-REFERENCE TO RELATED APPLICATIONS

This application is a continuation of U.S. patent application Ser. No. 17/666,206, filed on Feb. 7, 2022, which claims the benefit of U.S. Provisional Application No. 63/148,474, filed on Feb. 11, 2021, each of which is hereby incorporated by reference in its entirety.

### TECHNICAL FIELD

This disclosure relates to a material. More specifically, this disclosure relates to a composite material.

### BACKGROUND

Packaging and shipping temperature sensitive contents can pose challenges. The contents can spoil, destabilize, freeze, melt, or evaporate during storage or shipping if the temperature of the contents is not maintained or the packaging is not protected from hot or cold environmental conditions. In applications such as hot food delivery, customers can be dissatisfied if the contents have cooled to ambient temperature upon delivery. Contents such as food, pharmaceuticals, electronics, or other temperature sensitive items can be damaged if exposed to temperature extremes. Many insulated packages are bulky and difficult to store prior to use. Additionally, many insulated packages are specialized to ship or carry hot goods, chilled goods, or frozen goods, and shippers must maintain large stocks of specialized packaging for each application.

In addition, many insulated packages cannot be recycled and are often disposed of in landfills. Many insulation products that are touted as being environmentally friendly are more harmful to the environment than is readily apparent. For example, many insulation products are often advertised as being readily recyclable; however, these products are frequently not “curbside recyclable” wherein the materials can simply be placed in a recycling bin by the consumer at the time of discard. Instead, many of these recyclable materials must be physically separate into component parts, such as separating fiber-based insulations from plastic lining films, which then must be sent to separate recycling streams. If the end-user fails to comply with these requirements, these “recyclable” materials will still be sent to a landfill.

Also, many materials that are made from recycled materials have no further life after being used as packaging. For example, denim, wool, and other fiber materials are often recycled from clothing or other textiles to make insulation. However, the insulation itself is no longer recyclable and has no additional value. Instead, it is usually thrown away. While materials such as cotton, wool, and other natural fibers are often regarded as biodegradable under some circumstances, these products are not biodegradable on a helpful time scale when enclosed in plastic garbage bags and buried in an anaerobic environment, such as a landfill.

### SUMMARY

It is to be understood that this summary is not an extensive overview of the disclosure. This summary is exemplary and not restrictive, and it is intended to neither identify key or critical elements of the disclosure nor delineate the scope thereof. The sole purpose of this summary is to explain and exemplify certain concepts of the disclosure as an introduction to the following complete and extensive detailed description.

Disclosed is a method including mixing a plurality of ingredients to form a pre-foam mixture; foaming the pre-foam mixture to produce a water-based foam; mixing the water-based foam with cellulose fiber to form a composite material; and curing the composite material to define a maximum pore diameter of about 3 mm.

Disclosed is a composite including cellulose fiber, and a water-based foam binding the cellulose fiber, wherein the water-based foam defines a maximum pore diameter of about 3 mm.

Various implementations described in the present disclosure may include additional systems, methods, features, and advantages, which may not necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims. The features and advantages of such implementations may be realized and obtained by means of the systems, methods, features particularly pointed out in the appended claims. These and other features will become more fully apparent from the following description and appended claims, or may be learned by the practice of such exemplary implementations as set forth hereinafter.

### BRIEF DESCRIPTION OF THE DRAWINGS

The features and components of the following figures are illustrated to emphasize the general principles of the present disclosure. The drawings are not necessarily drawn to scale. Corresponding features and components throughout the figures may be designated by matching reference characters for the sake of consistency and clarity.

FIG. 1 is a perspective view of a composite comprising cellulose and foam in accordance with one aspect of the present disclosure.

FIG. 2 is a perspective view of a step in forming a mixture comprising starch in accordance with another aspect of the present disclosure.

FIG. 3 is a side view of the step in forming the mixture of FIG. 2.

FIG. 4 is a front view of a wand of a foam generator in accordance with another aspect of the present disclosure.

FIG. 5 is a front view of a reservoir of the foam generator of FIG. 4.

FIG. 6 is a front view of a reservoir of the foam generator of FIG. 4.

FIG. 7 is a front perspective view of a step for curing the composite of FIG. 1 in an oven.

FIG. 8 is a process schematic illustrating one aspect of an industrial process for producing the composite material 100 in accordance with another aspect of the present disclosure.

FIG. 9 is a process schematic illustrating another aspect of an industrial process for producing the composite material 100 in accordance with another aspect of the present disclosure.

### DETAILED DESCRIPTION

The present disclosure can be understood more readily by reference to the following detailed description, examples, drawings, and claims, and the previous and following description. However, before the present devices, systems, and/or methods are disclosed and described, it is to be understood that this disclosure is not limited to the specific devices, systems, and/or methods disclosed unless otherwise specified, and, as such, can, of course, vary. It is also to be understood that the terminology used herein is for the purpose of describing particular aspects only and is not intended to be limiting.

The following description is provided as an enabling teaching of the present devices, systems, and/or methods in its best, currently known aspect. To this end, those skilled in the relevant art will recognize and appreciate that many changes can be made to the various aspects of the present devices, systems, and/or methods described herein, while still obtaining the beneficial results of the present disclosure. It will also be apparent that some of the desired benefits of the present disclosure can be obtained by selecting some of the features of the present disclosure without utilizing other features. Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

As used throughout, the singular forms “a,” “an” and “the” include plural referents unless the context clearly dictates otherwise. Thus, for example, reference to “an element” can include two or more such elements unless the context indicates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

For purposes of the current disclosure, a material property or dimension measuring about X or substantially X on a particular measurement scale measures within a range between X plus an industry-standard upper tolerance for the specified measurement and X minus an industry-standard lower tolerance for the specified measurement. Because tolerances can vary between different materials, processes and between different models, the tolerance for a particular measurement of a particular component can fall within a range of tolerances.

As used herein, the terms “optional” or “optionally” mean that the subsequently described event or circumstance can or cannot occur, and that the description includes instances where said event or circumstance occurs and instances where it does not.

The word “or” as used herein means any one member of a particular list and also includes any combination of members of that list. Further, one should note that conditional language, such as, among others, “can,” “could,” “might,” or “may,” unless specifically stated otherwise, or otherwise understood within the context as used, is generally intended to convey that certain aspects include, while other aspects do not include, certain features, elements and/or steps. Thus, such conditional language is not generally intended to imply that features, elements and/or steps are in any way required for one or more particular aspects or that one or more particular aspects necessarily include logic for deciding, with or without user input or prompting, whether these features, elements and/or steps are included or are to be performed in any particular aspect.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific aspect or combination of aspects of the disclosed methods.

Disclosed is a composite material and associated methods, systems, devices, and various apparatus. The composite material can comprise cellulose fiber and foam. It would be understood by one of skill in the art that the composite material is described in but a few exemplary embodiments among many. No particular terminology or description should be considered limiting on the disclosure or the scope of any claims issuing therefrom.

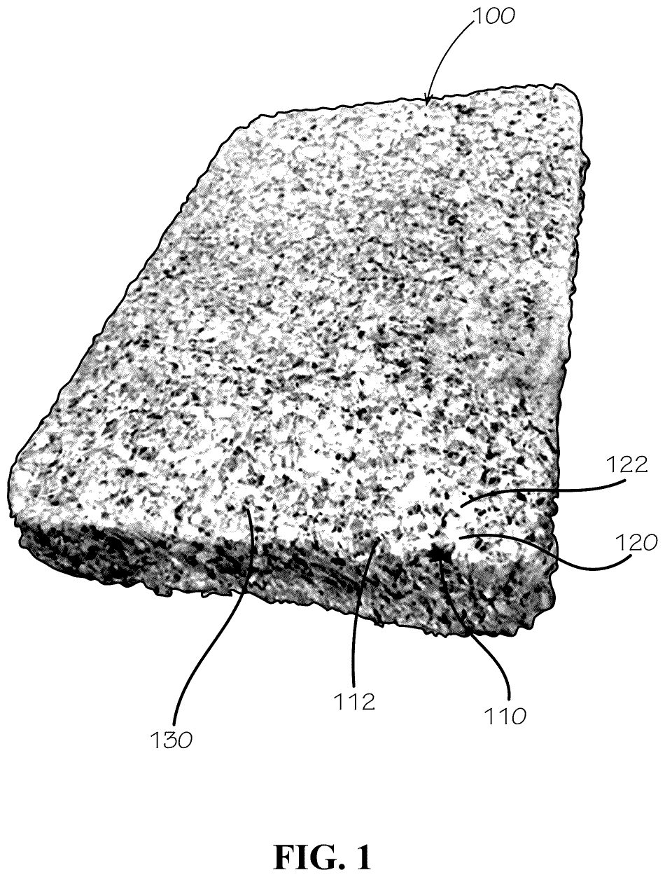

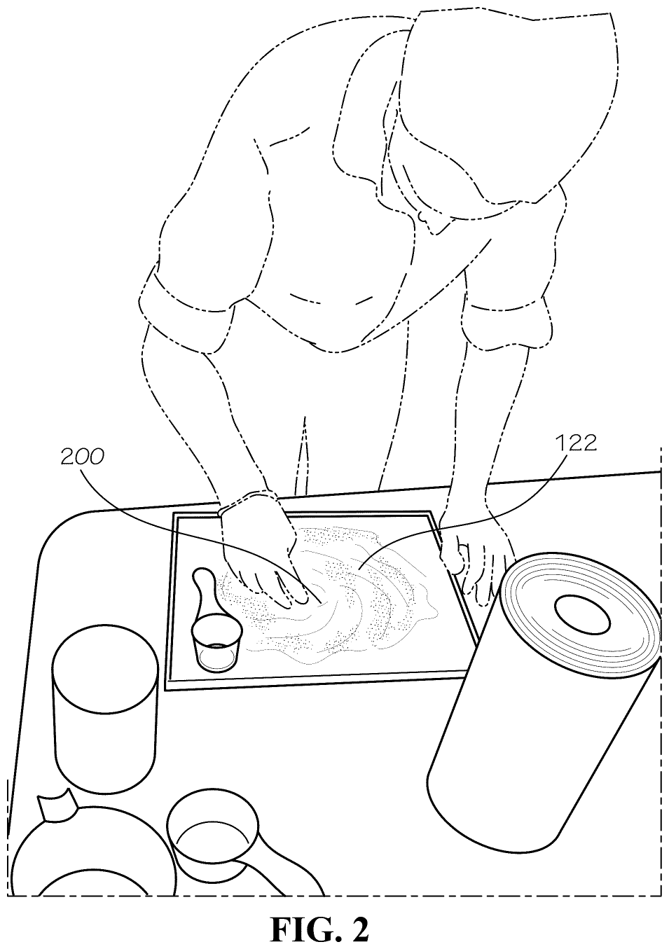

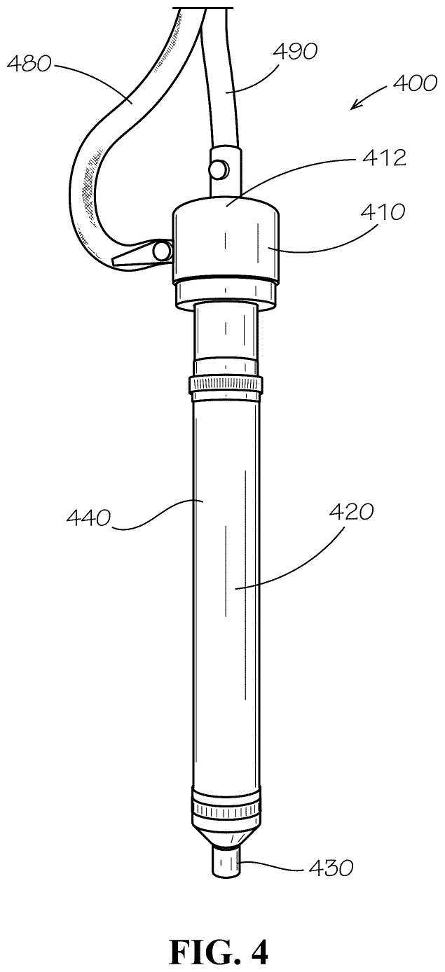

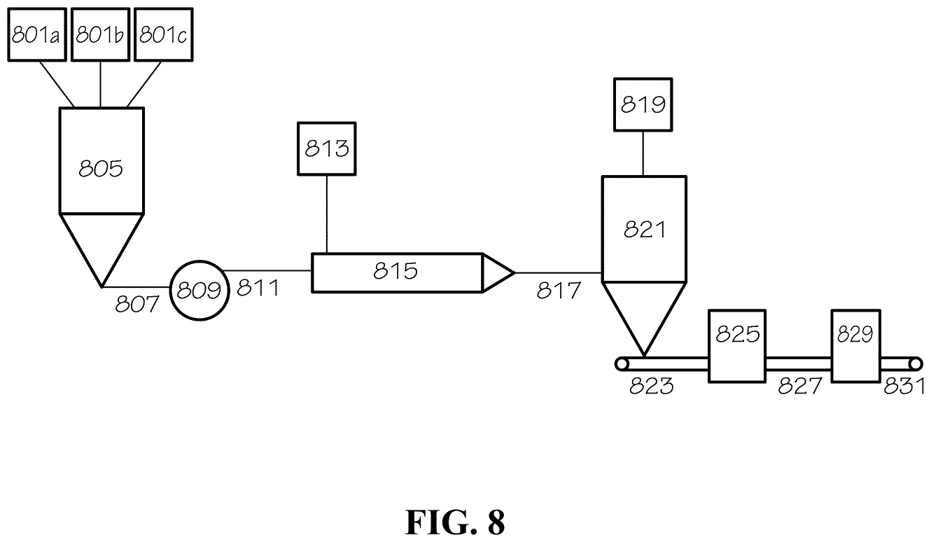

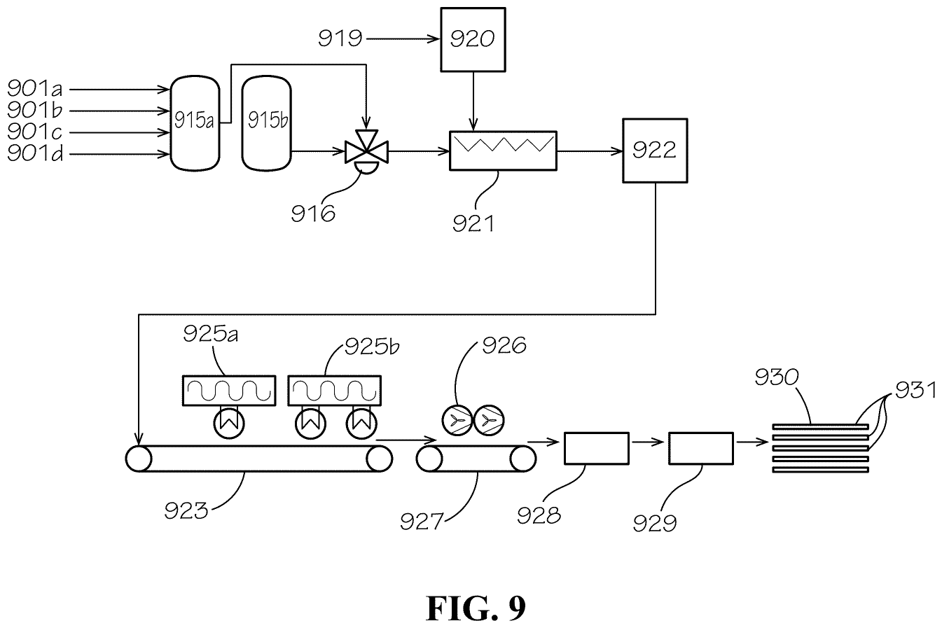

FIG. 1 is a perspective view of a composite material 100 in accordance with one aspect of the present disclosure. The composite material 100 can comprise cellulose 110 and foam 120. The composite material 100 can be produced through a series of manufacturing steps. In a first step, a pre-foam mixture 200 (shown in FIG. 2) can be formed, which is discussed below in greater detail with respect to FIGS. 2, 3, 8, and 9. In a second step, the pre-foam mixture 200 can be processed to create the foam 120, sometimes referred to simply as a “foaming” step, as discussed in greater detail below with respect to FIGS. 4-6, 8, and 9. In a third step, the cellulose 110 can be mixed into the foam 120 to create an uncured form of the composite material 100, in a process that can involve a single or multiple stages, as discussed with respect to FIGS. 8 and 9.

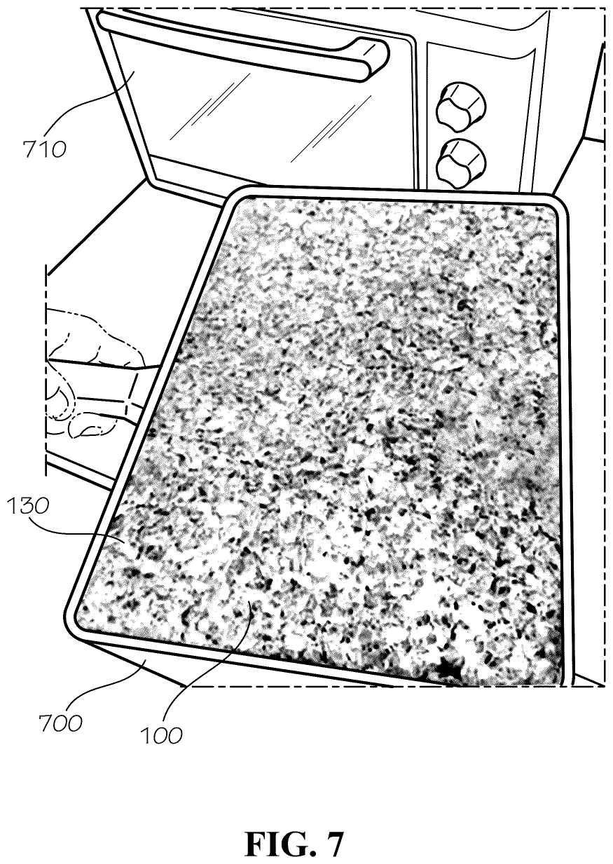

In the final two steps, which can take place in either order or, at times, simultaneously, the uncured composite material 100 can be shaped and cured, as described in greater detail with respect to FIGS. 7-9. For example, in some aspects, the uncured composite material 100 can be deposited in a mold 700 (shown in FIG. 7) and then cured, such as by baking in an oven 710 (shown in FIG. 7) or microwave, passing through a heating tunnel, or curing through any other suitable process, for example and without limitation. As the composite material 100 cures, the foam 120 and the cellulose 110 can dry out and harden. In some aspects, the foam 120 and the cellulose 110 can bond together through mechanisms such as hydrogen bonding, surface bond adhesion, or other bonding mechanisms.

In some aspects, uncured composite material 100 can be cured without a precisely defined form, such as by depositing, or extruding, the uncured composite material 100 on a conveyor mechanism and then passing the uncured composite material 100 through or under a curing unit in a continuous or batch operation, such as an oven, infrared lamp, heated blower, ultrasonic dryer, vacuum dryer, microwave heater, or other suitable curing mechanism or combinations thereof, thereby producing cured composite material 100 in a raw, or unformed, state. The unformed composite material 100 can then be shaped, such as by cutting, milling, stamping, or any other suitable shaping process or processes. In some aspects, the composite material 100 can be simultaneously shaped and cured. For example and without limitation, the uncured material can be simultaneously extruded and cured. Such processes can be used to produce elongated forms, sheets, or loose shapes, such as packing peanuts, for example and without limitation.

In some aspects, the shaping process(es) can produce basic raw material shapes, such as sheets, boards, blocks, bricks, or elongated stock, for example and without limitation. In some aspects, the shaping process(es) can produce finished or semi-finished products with shapes of varying degrees of intricacy. For example and without limitation, the shaping steps can produce a core for a cooler lid or body, a finished cooler lid or body, drink koozies, custom-formed shipping inserts, egg cartons or other food/beverage containers, padded inserts for safety equipment such as helmets, building materials such as doors, cabinet panels, or shelves, or any other suitable product usage.

Various exemplary aspects of the overall process at an industrial scale are described below with respect to FIGS. 8 and 9.

Returning to FIG. 1, the cellulose 110 can be in the form of cellulose fiber 112, and the foam 120 can bind the cellulose fiber 112 together. The cellulose fiber 112 can be individual fibers or pieces comprising multiple fibers. In the present aspect, the composite material 100 can be shaped to form a batt 130, such as an insulation batt, for example and without limitation. In some aspects, the composite material 100 can provide an insulation R-value of approximately 3-4 per inch of material thickness. In some aspects, composite material 100 can be utilized as a structural material, acoustic insulation, or other purpose, as described below in greater detail.

The cellulose fiber 112 can be recycled fiber. For example and without limitation, the cellulose fiber 112 can be derived from recycled paper and cardboard products. In some aspects, these materials can be shredded, such as to form strips or irregular and varied shapes. In some aspects, waste materials from the manufacture of paper and pulp-based products can be utilized as a source of cellulose fiber 112. For example and without limitation, edge trim from a paper mill can be utilized. Edge trim is a waste product from paper manufacturing and conversion wherein the edge of sheets are trimmed off. In some aspects, the edge trim can be put through a grinder to obtain pieces of cellulose fiber 112 at a desired size or range of sizes. In some aspects, pieces of cellulose fiber 112 can exceed about 13 mm. In some aspects, pieces of cellulose fiber 112 can be approximate 0.2 mm or less in size. In some aspects, the waste from a box plant can be utilized, such as the leftovers portions after die cutting a corrugate blank, for example and without limitation.

In some aspects, the cellulose fiber 112 can be virgin material. For example and without limitation, the cellulose fiber 112 can be derived from wood or other plant or tree products. In some aspects, the cellulose fiber 112 can be chopped to shorten the cellulose fiber 112 or produce a uniform range of lengths. For example and without limitation, the cellulose fiber 112 can be cut to sizes such as 1″ by 0.5″ in size or less. In some aspects, the cellulose fiber 112 can be 0.5″ by 0.25″ in size or less. In some aspects, the cellulose fiber 112 can be the type of cellulose fiber used for blown insulation installation, such as the cellulose insulation sold as Nu-Wool® by Nu-Wool Co., Inc. of Jenison, Michigan.

In some aspects, the cellulose fiber 112 can come from a waste source, such as sawdust from the lumber and/or wood manufacturing industries or ultra-short fiber rejects from the paper product manufacturing industry. These sources of cellulose fiber 112 can be utilized to form aspects of the composite material 100 that can be suited for manufacturing low-density paneling or very high-density flame logs, for example and without limitation. Normally, ultra-short cellulose fiber that is too short for making paper or cardboard is burned in a furnace, but these fibers can be utilized for forming the composite material 100, thereby extending the re-useable lifespan of cellulosic materials. A range of useful lengths of the cellulose fiber 112 for making the composite material 100 can be from less than a hundredth of an inch (0.01″) to several inches in length. In some aspects, some or all of the cellulose fibers 112 can be up to or exceeding a foot (12″) in length. In some aspects, some or all of the cellulosic fibers 112 can be up to or exceeding a yard (36″) in length.

The foam 120 can comprise starch 122. In some aspects, the starch 122 can be un-gelatinized corn starch. In some aspects, the starch 122 can be modified starch. In some aspects, the foam 120 can be predominantly starch-based. The foam 120 can comprise additives in addition to the starch. The foam 120 can be formed by premixing the materials, such as starch and additives, to form the pre-foam mixture 200. In one aspect, the pre-foam mixture 200 can comprise by volume the following ingredients:

| | | | |
|---|---|---|---|
| Water | 1800 | ml | ~73.2% |
| Starch | 300 | ml | ~12.2% |
| Liquid egg whites | 200 | ml | ~8.1% |
| Polyvinyl acetate (PVA) glue | 120 | ml | ~4.9% |
| Sodium Laureth Sulfate (27% Solution) | 35 | ml | ~1.4% |
| Baking soda | 2.5 | ml | ~0.1% |
| Citric acid | 2.5 | ml | ~0.1% |

In one aspect, this composition of the pre-foam mixture 200 can be combined with 9500 ml (˜360 g) of pulp (cellulose fiber 112) after the pre-foam mixture 200 has been foamed. In other aspects, the proportions of the ingredients can be significantly altered, and/or some ingredients can be omitted. For example and without limitation, the proportions of water and starch can be individually increased or decreased by 20% or more from the indicated percentage. To illustrate, the percentage of starch 122 by volume can be from ˜9.9% (a 20% decrease) to ˜14.9% (a 20% increase). Particularly in structural applications of the composite material 100, the percentage of starch 122 can be increased by up to 100% or more. The ratio of the pre-foam mixture 200 mixed with the cellulose 110 can also greatly vary. In some aspects, the PVA glue can be omitted. In some aspects, gelatin, agar, and/or other adhesives can be utilized in place of PVA glue. In some aspects, such as those without the PVA glue for example and without limitation, the percentage of starch 122 can be increased, and/or the pre-foam mixture 200 can comprise gelatinized starch. In some aspects, baking soda can be omitted. In some aspects, such as those omitting the baking soda for example and without limitation, the pre-foam mixture 200 can comprise baking powder. In some aspects, the liquid egg whites can be omitted. In some aspects, such as those omitting the liquid egg whites for example and without limitation, the pre-foam mixture 200 can comprise anhydrous (dry) egg whites and/or gluten protein. In some aspects, boric acid or another suitable material can be added to the pre-foam mixture 200, which can prevent mold and other biologic infestations.

In some aspects, the pre-foam mixture 200 can comprise sodium laureth sulfate, starch, sodium bicarbonate, and/or egg whites. In some aspects, the pre-foam mixture 200 can comprise sodium coco sulfate, PVA glue, silica, and/or xanthan gum. In some aspects, sodium coco sulfate can be utilized in place of sodium laureth sulfate. In some aspects, the pre-foam mixture 200 can comprise methyl cellulose, ethyl cellulose, and/or hydroxypropyl methyl cellulose.

For example and without limitation, in some aspects, the pre-foam mixture 200 can exclude starch. In one starchless aspect, the pre-foam mixture 200 can comprise the following ingredients by weight:

| Water | ~1000 | g |
|---|---|---|
| Liquid PVA Glue (20% PVA Solution) | ~75 g (Range: 25 g-100 g) | |
| Water: | ~60 | g |
| PVA: | ~15 | g |
| Sodium Coco Sulfate | ~1 g (Range: 0.5 g-5 g) | |
| Xanthan Gum | ~3 g (Range: 1 g-10 g) | |
| Hydrated Hydroxypropyl Methyl Cellulose: | | |
| Hydroxypropyl Methyl Cellulose | ~2 g (Range: 0 g-10 g) | |
| Water | ~18 | g |
| Total | ~1100 | g |

In some aspects, approximately 4 gallons of foam 120 can be generated from 1100 g of the pre-foam mixture 200 prepared according to the above formulation. In some aspects, approximately 4 gallons of the foam 120 can be combined with the cellulose fiber 112 to generate approximately 2 square feet of composite material 100, which at a thickness of 1″ can define a mass of 110 g per square foot (˜1184 grams per square meter (GSM)), in some aspects.

In some aspects, a dry formulation of the pre-foam mixture 200 can be prepared, which can include the cellulose fiber 112 prior to adding water and foaming the mixture. One aspect of the dry formulation can comprise the following:

| | | |
|---|---|---|
| PVA | ~15 | g |
| Sodium Coco Sulfate | ~3 | g |
| Xanthan Gum | ~2 | g |
| Hydroxypropyl Methyl Cellulose | ~2 | g |
| Total | ~147 | g |

Approximately 1000-1100 g of water (preferably about 1078 g of water) can be added to the dry formulation to create the pre-foam mixture 200, which can then be foamed. Once foamed, approximately 125 g of fiber can be added to the foam 120 to produce uncured composite material 100.

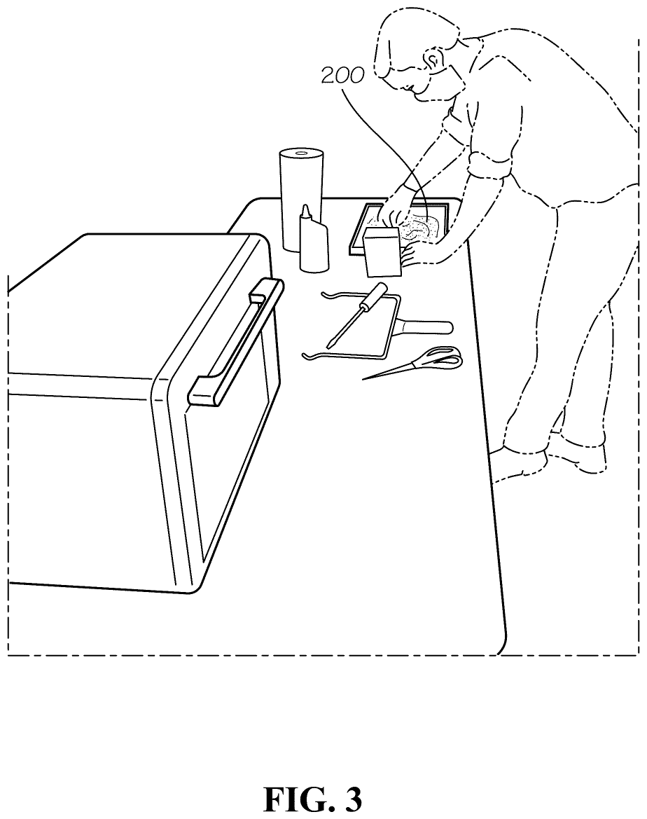

FIGS. 2 and 3 demonstrate a step in mixing the pre-foam mixture 200. The materials can be pre-mixed in an external setting, as shown. In some aspects, such as external settings, the materials can be mixed to form the pre-foam mixture 200 in large batches or in a continuous process. In some aspects, mixing can be accomplished in multiple phases where different ingredients, or portions of ingredients, are added in separate steps.

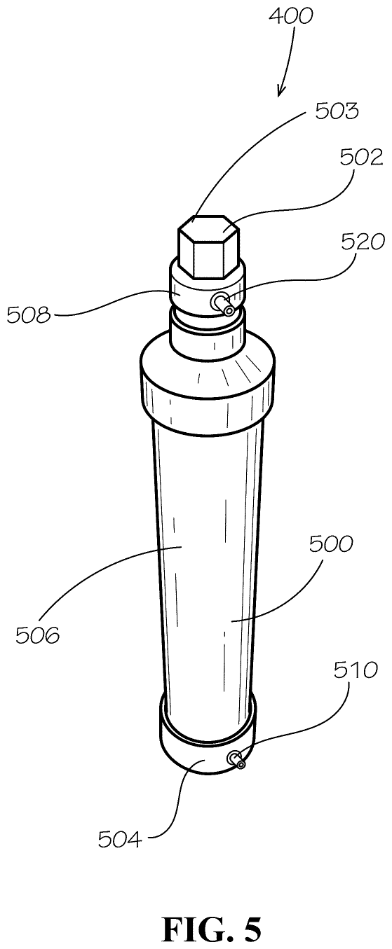

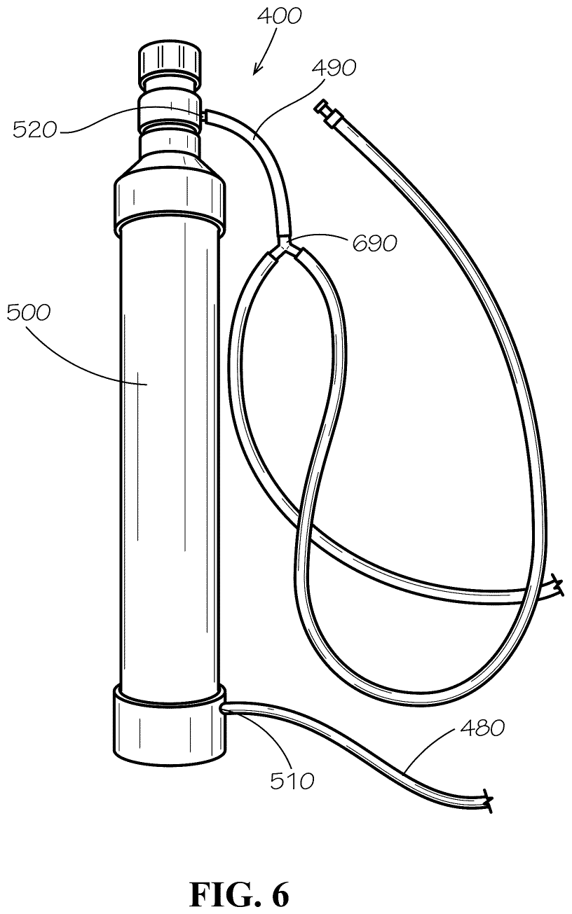

Once mixed, the pre-foam mixture 200 can be placed in a foam generator 400 (shown in FIGS. 4-6) to create the foam 120 (shown in FIG. 1). The foam generator 400 can comprise a wand 410 (shown in FIG. 4), a reservoir 500 (shown in FIGS. 5 and 6), a mixture conduit 480 (shown in FIGS. 4 and 6), and an air conduit 490 (shown in FIGS. 4 and 6). The wand 410 can comprise a mixing chamber 412 at one end of the wand 410 and an outlet nozzle 430 at an opposite end of the wand 410. A foam generation conduit 420 can extend from the mixing chamber 412 to the outlet nozzle 430. The foam generation conduit 420 can be at least partially filled with foam generation media 440, which is visible within the foam generation conduit 420 because the foam generation conduit 420 can optionally be transparent, as shown in FIG. 4. The foam generation media 440 can be steel wool in the present aspect; however, in other aspects, different media can be utilized.

Turning to FIG. 5, the reservoir 500 can define a first end 502 and a second end 504. A removable fill cap 503 of the reservoir 500 can be positioned at the first end 502. The reservoir 500 can comprise a neck 508 extending between the fill cap 503 and a main body 506 of the reservoir 500, which can define the second end 504. The main body 506 can define an outlet 510 at the second end 504. The neck 508 can define an inlet 520. The main body 506 can be filled with the pre-foam mixture 200 (shown in FIG. 2) by removing the fill cap 503 and pouring the pre-foam mixture 200 into the neck 508.

Turning to FIG. 6, one arm of the air conduit 490 can be coupled to the inlet 520, and the mixture conduit 480 can be coupled to the outlet 510. The conduits 480,490 can comprise materials such as tubing, hoses, piping, or any other suitable material capable of transporting a pressurized fluid. The air conduit 490 can supply pressurized air to the reservoir 500, which can force the pre-foam mixture 200 (shown in FIG. 2) out from the outlet 510 to the mixture conduit 480.

Returning to FIG. 4, the mixture conduit 480 can feed the pre-foam mixture 200 into the mixing chamber 412 of the wand 410, and the air conduit 490 can feed compressed air into the mixing chamber 412. The flow of compressed air into the mixing chamber 412 can force the pre-foam mixture 200 through the foam generation media 440, thereby creating the foam 120 by entrapping the air within bubbles formed from the pre-foam mixture 200, which can then be sprayed out of the outlet nozzle 430.

A splitting valve 690 (shown in FIG. 6) in the air conduit 490 can control the ratio of air flowing to the reservoir 500 and to the wand 410. Supplying more air to the reservoir 500 can increase the ratio of the pre-foam mixture 200 to the air supplied to the wand 410, thereby resulting in a more watery, denser foam 120. Decreasing the air supplied to the reservoir 500 can decrease the ratio of the pre-foam mixture 200 to the air supplied to the wand 410, thereby resulting in a fluffier, less dense foam 120. For example and without limitation, a denser foam 120 can be desirable for producing a stronger composite material 100, such as for structural uses. A lighter foam 120 can be desirable for insulation applications, or where using less materials is desirable, such as creating loose filler, such as packing peanuts, from the composite material 100.

For example and without limitation, the pre-foam mixture 200 can define a density of approximately 1 to 1.1 g/ml. In some aspects, 1100 ml of pre-foam mixture 200 can be foamed to form about 4 gallons (about 15,141.6 ml) of the foam 120. The density of the pre-foam mixture 200 can be approximately 13-14 times greater than the density of the foam 120.

Once the foam 120 is formed, the foam 120 and the cellulose 110 (shown in FIG. 1) can be mixed together to form the composite material 100. For example and without limitation, the foam 120 and the cellulose 110, in the form of the cellulose fiber 112, can be mixed together in equal parts by volume in a container and stirred, such as with a mixing auger. In some aspects, the container can be a 5 gallon bucket. In other aspects, a mixing vessel, such as an industrial mixer, can be used to form the composite material 100. In some aspects, approximately 140-180 g of cellulose fiber 112 can be added to 1100 g of the foam 120. The resulting mixture can define a density of about 75-100 g/500 ml.

After mixing the composite material 100, the uncured composite material 100 can be cured, such as by cooking or baking the uncured composite material 100, to create solid forms of varying consistencies. For example and without limitation, the uncured composite material 100 can be baked at 350 degrees Fahrenheit to cure the composite material 100. In other aspects, the composite material 100 can be cured at higher or lower curing temperatures. For example and without limitation, the composite material 100 can be heated to a temperature of 270 degrees Fahrenheit or greater, which can steam sterilize the composite material 100. Steam sterilization can be particularly desirable in aspects of the composite material 100 comprising starch and/or protein(s). For example and without limitation, a tunnel microwave can be utilized to cure a 0.75″ thick piece of composite material 100 over a period of 720 seconds at 38 kW output.

FIG. 7 demonstrates one alternative for curing the composite material 100 wherein the composite material 100 can be placed in the mold 700, such as a pan, and the composite material 100 can then be baked in the oven 710 to cure the composite material 100. The step shown can be an example of batch curing, wherein a set quantity of composite material 100 is cured in a discrete step. In the example shown in FIG. 7, once the composite material 100 has cured, the batt 130 of FIG. 1 can be formed. The degree to which the foam 120 and cellulose fiber 112 are mixed prior to curing can control the amount of air trapped into the uncured composite material 100, which can in turn affect the degree to which the foam 120 expands when the composite material 100 is cured.

Additionally, the degree to which the foam 120 expands as the composite material 100 cures can also be controlled by the curing method. The composite material 100 can be cured with the oven 710, as shown, a microwave, a dehydrator, an ultrasonic dryer, an air dryer, or an infrared heater, for example and without limitation. In some aspects, the composite material 100 can be cured in a continuous process (as opposed to batch curing), such as by passing the composite material 100 on a conveyor under an industrial heater, for example and without limitation.

The oven 710, dehydrator, and air dryer can be optimized for maintaining a shape of the composite material 100 while curing without further expansion of the foam 120 component, particularly when utilizing the mold 700. The mold 700 shown can be an open mold; however, in other aspects, a closed mold can be utilized which fully encloses the composite material 100, with the exception of one or more vent holes or filling holes, to control the final shape of the composite material 100. Through oven cooking, in some aspects, the composite material 100 can be formed into sheets of insulation with density as low as 57,000 grams per cubic meter, equating to approximately 1450 grams per square meter for a 1″-thick panel. In some aspects, oven cooking can be used to mold the composite material 100, as shown with mold 700, to different shapes and/or thicknesses.

The microwave can heat and expand both air and water molecules trapped in the uncured composite material 100, causing the foam 120 component of the composite material 100 to expand and more bubbles to be formed within the foam 120. In particular, the starch 122 portion of the foam 120 can expand and create a more rigid structure as well as to expand to fit a larger mold. The formulation of the composite material 100 can be the same for both the oven-cooked and micro-wave cooked aspects; however, because of the increased expansion of the foam 120 component of the composite material 100, even lower densities can be achieved than 41,500 grams per cubic meter. In some aspects, the average bubble, or pore, diameter in cured foam 120 can be approximately 1-2 mm. In some aspects, the bubbles, or pores, can have a maximum diameter of about 3 mm.

The low densities achieved can be desirable for forming insulation products from the composite material 100. In other aspects, the proportion of starch 122 in the composite material 100 can be increased to increase the rigidity of the composite material 100. In some aspects, a ratio of glue, such as PVA for example and without limitation, to cellulose fiber 112 can be altered to affect the rigidity of the composite material 100. Generally, a higher glue-to-fiber ratio by weight can make the composite material 100 harder, while a lower glue-to-fiber ratio by weight can make the composite material 100 softer. For example and without limitation, a 0.75:1 ratio by weight of PVA to cellulose fiber 112 can produce a very firm composite material 100, which can be similar to sheetrock. This can be desirable for making structural products from the composite material 100, similar to that of plywood or medium density fiberboard (MDF). The ultra-short waste cellulose fibers referenced above can be well-suited for use with the high-starch formulation for making structural products. In some aspects, the structurally-oriented formulations of the composite material 100 can be suitable for machining, such as to create furniture, cabinetry, or ornamentally shaped products, for example and without limitation. A length of the cellulose fiber 112 can also affect the rigidity of the composite material 100. For example and without limitation, longer fiber lengths of the cellulose fiber 112 can increase pliability of the composite material 100.

Regardless of cooking method, the composite material 100 can be non-toxic. Additionally, the composite material 100 can be fully recyclable, including single-stream recyclable, and repulpable. In the present aspect, the composite material 100 and all components thereof can be repulpable in accordance with the requirements of the Aug. 16, 2013, revision of the “Voluntary Standard For Repulping and Recycling Corrugated Fiberboard Treated to Improve Its Performance in the Presence of Water and Water Vapor” provided by the Fibre Box Association of Elk Grove Village, IL which is hereby incorporated in its entirety.

When repulped, virtually all of the cellulose 110 can be recovered, allowing for multiple reuses. The starch 122 can be water soluble, and the additives in the foam 120 can be water based, so the foam 120 component can disintegrate during repulping. Additionally, due to the porous nature of the foam 120, the weight of the starch 122 and additives in a given volume of the composite material 100 is low, so these materials can comprise a relatively small portion of the composite material 100 by weight, leaving a greater percentage of the composite material 100 to be from the cellulose 110. This can aid the composite material 100 in breaking down rapidly enough in a paper mill to not cause adverse effects in repulping and manufacturing of recycled paper products. Based on the properties of the foam 120 and its additives, the rate at which the composite material 100 comes apart during repulping can be controlled. In particular, the percentage of starch 122 in the composite material 100 can be altered to optimize pulp recovery during the repulping process.

FIG. 8 is a process schematic illustrating one aspect of an industrial process for producing the composite material 100 in accordance with another aspect of the present disclosure.

In some aspects, water, starch 122, and additives can be fed into a first mixing vessel 805 from various storage vessels, or tanks, 801a,b,c. The number of vessels 801a,b,c should not be viewed as limiting, and the number of vessels 801a,b,c may vary according to the number of separate ingredients being combined to form the pre-foam mixture 200. In a continuous production process, the ingredients of the pre-foam mixture 200 can be fed at controlled rates into the first mixing vessel 805 to achieve consistent compositions. In other aspects, such as a batch process, some or all of the ingredients can be fed into the first mixing vessel 805 by manually measuring and dumping the ingredients into the first mixing vessel 805.

In some aspects, the first mixing vessel 805 can be a dynamic mixing vessel 805 that can stir or mix the ingredients until the mixture is substantially homogenous before feeding the pre-foam mixture 200 into a first mixture conduit 807. The first mixture conduit 807 can feed the pre-foam mixture 200 to a pump 809, which can pressurize the pre-foam mixture 200 and feed the pre-foam mixture 200 through a second mixture conduit 811 to a foaming vessel 815. In some aspects, the pump 809 may not be necessary, and the pre-foam mixture 200 can be gravity fed. In other aspects, the pre-foam mixture 200 may not be homogenous when fed from the first mixing vessel 805, and the mixture conduits 807,811 may comprise inline mixing equipment, including static mixing equipment, such as helical or plate mixers for example and without limitation, and/or dynamic mixing equipment, such as paddle or ribbon mixers for example and without limitation.

The foaming vessel 815 can receive the pre-foam mixture 200 and air from a compressed air source 813. The foaming vessel 815 can pass the pre-foam mixture 200 and air through foam generation media, as similarly discussed above with respect to FIG. 4, to produce foam 120. The foam 120 can be fed through a foam conduit 817 to a second mixing vessel 821. In some aspects, the foam conduit 817 can include a pump or compressor (not shown) to aid in transporting the foam 120 to the second mixing vessel 821, similar to the pump 809.

In the second mixing vessel 821, cellulose 110 can be fed from a storage vessel 819 into the second mixing vessel 821 to be mixed with the foam 120. In some aspects, the second mixing vessel 821 can be a dynamic mixing vessel 821 that can mix the cellulose 110 and foam 120 to create a homogenous uncured composite material 100, which can then be fed through a curing and a shaping process 825,829. In some aspects, the cellulose 110 can be mixed with the foam 120 in several stages, such as with multiple mixing vessels, a combination of various static and dynamic mixers, a combination of mixing vessels and inline mixers, or multiple inline mixers, for example and without limitation. For example, the uncured composite material 100 can be fed through a composite conduit (not shown), which can include static or dynamic inline mixers, as similarly discussed with respect to mixture conduits 807,811 and pump 809.

The uncured composite material 100 can be transported through the curing and shaping processes 825,829, such as with a conveyor 823 for example and without limitation. In other aspects, the uncured composite material 100 can be both shaped and cured in a combined process, such as by directly extruding particles of the composite material 100 into a curing oven or dryer, for example and without limitation.

As discussed above, the curing and shaping processes 825,829 can occur in either order. For example, in some aspects, element 825 can represent the shaping process, which can be accomplished by depositing the uncured composite material 100 into molds 700 that can be fed by the conveyor 823 through one or more curing processes 829, and possibly additional shaping processes (not shown), such as finishing the cured composite material 100 after removal from the molds 700.

In some aspects, the uncured composite material 100 can be directly deposited to the conveyor 823, and element 825 can represent the curing process, which can cure the composite material 100 as it passes through on the conveyor 823. A second portion of the conveyor 827 or a separate conveyer 827 can then carry the unshaped cured composite material 100 through to element 829, which can represent the shaping process 829, and finished or semi-finished products can be fed out by a third part of the conveyor 831, or a third conveyor, after being shaped.

FIG. 9 is a process schematic illustrating another aspect of an industrial process for producing the composite material 100 in accordance with another aspect of the present disclosure.

In the aspect shown, the process can comprise a pair of foam generation tanks 915a,b. Various material streams 901a-d can be fed into each of the foam generation tanks 915a,b. Though four material streams 901a-d are shown, this number should not be viewed as limiting. Greater or fewer than four material streams 901a-d can be fed into the foam generation tanks 915a,b, and each material stream 901a-d can carry a single material or mixture of materials in various aspects. The material streams 901a-d can supply the ingredients of the pre-foam mixture 200. In the present aspect, the material streams 901a-d can supply at least water, a glue (such as PVA for example and without limitation), xanthan gum, and sodium laureth sulfate. In some aspects, sodium coco sulfate can be utilized in addition or in place of sodium laureth sulfate. In some aspects, the material streams 901a-d can further supply hydroxypropyl methyl cellulose, methyl cellulose, and/or ethyl cellulose to the foam generation tanks 915a,b. In various aspects, the material streams 901a-d can carry any of the recipes, formulations, individual ingredients, or combinations thereof disclosed herein to the foam generation tanks 915a,b. The foam 120 can be generated in the foam generation tanks 915a,b.

The foam generations tanks 915a,b can be connected to a three-way valve 916. A mixer 921, such as a screw mixer or any other suitable type of mixer, can be connected to the three-way valve 916 downstream from the foam generations tanks 915a,b. The foam generations tanks 915a,b can be operated on a shift, or batch, basis, and the three-way valve 916 can be operated to alternately connect the separate foam generation tanks 915a,b in communication with the mixer 921, such that the mixer 921 and remainder of the process can be operated continuously. For example, foam generation tank 915a can supply the foam 120 to the mixer 921 while the foam generation tank 915b is being cleaned and a new batch of foam 120 is being formed within foam generation tank 915b. Once foam generation tank 915a is low or out of foam 120, the three-way valve 916 can be switched to supply from foam generation tank 915b to the mixer 921, and the process can be repeated indefinitely for continuous operation.

Cellulose 110, such as cellulose fiber 112, can be fed as a material stream 919 to a fiber shredder 920. In some aspects, the cellulose 110 can be a waste stream, such as trimmings from a paper mill or other pulp-based manufacturing facility. In some aspects, the waste stream can be from another facility, such as a saw mill for example and without limitation. In some aspects, the cellulose 110 can originate from another source, such as a recycling facility or garbage dump. The fiber shredder 920 can process the cellulose 110 into a desired shape, size, and form of cellulose fiber 112, which can be fed into the mixer 921 to be mixed with the foam 120 to form the composite material 100, in an uncured state.

The mixer 921 can supply the uncured composite material 100 to a slurry dispensing unit 922, which can deposit the uncured composite material 100 to a curing conveyor 923. The curing conveyor 923 can pass the composite material 100 under at least one curing unit 925a,b. In some aspects, the curing conveyor 923 can extend through a tunnel. In the present aspect, one or both of the curing units 925a,b can be microwave heaters; however, any other type of heaters or dryers can be suitable, such as infrared, ultrasonic, or air dryers for example and without limitation.

In some aspects, the at least one curing unit 925a,b can operate as a two-stage curing step. For example and without limitation, a first curing unit 925a of the at least one curing unit 925a,b can operate at a lower power setting, which can set the uncured composite material 100 into shape. For example the first curing unit 925a can heat the uncured composite material 100 until it hardens, without heating distorting the uncured composite material 100 such as through excessive foam generation due to overheating. Once the composite material 100 has set and begun to harden, a second curing unit 925b of the at least one curing unit 925a,b can operate at a higher power setting to fully dry the composite material 100.

In some aspects, the curing conveyor 923 can comprise a mesh web. The curing conveyor 923 can operate at a speed of about 10-30 linear feet per minute. In some aspects, the curing conveyor 923 can operate at a speed of about 15-20 linear feet per minute. In some aspects, the curing conveyor 923 can operate at a speed of about 18 linear feet per minute. The curing conveyor 923 can define any width; however, as one non-limiting example, an aspect of the curing conveyor 923 with an 8-foot-wide web operating at 18 linear feet per minute produces 144 ft² per minute.

In some aspects, the curing conveyor 923 can carry a plurality of molds, which can receive and roughly shape the uncured composite material 100 as the material is cured. The molds can create basic shapes, such as rectangular sheets for example and without limitation, or more intricate shapes, such as the rough shape of various parts, brackets, components, etc. In some aspects, the molds can be attached to a web of the curing conveyor 923. In some aspects, the molds can be built into the web. The web of the curing conveyor 923 can comprise fabric, screen (such as a fiberglass screen for example and without limitation), polymers, such as polypropylene for example and without limitation, or other suitable materials.

After curing, a drying conveyor 927 can carry the composite material 100 through an air dryer 926. The air dryer 926 can further extract any residual moisture from the composite material 100.

After final drying, the composite material 100 can pass through a laminator 928 and a shaping stage 929. The order of these steps should not be viewed as limiting. The composite material 100 can be shaped and then laminated or laminated and then shaped. In some aspects, the composite material 100 can be shaped, laminated, and subjected to additional shaping or finishing steps. In the present aspect, the laminator 928 can laminate the composite material 100 with a film, such as paper, plastic, or another suitable material. The film can be applied to one side or both sides, and the film can partially or fully encapsulate the composite material 100. In some aspects, the laminator 928 can deposit a spray, which can form a coating around some or all of the composite material 100. In some aspects, the coating can encapsulate the material. In some aspects, the coating can be provided to reduce dust and loose material from falling off the composite material 100. In some aspects, the coating can strengthen the composite material 100. The spray can include glues, lacquers, acrylics, paints, or other suitable materials. In some aspects, thinned PVA glue can be sprayed onto the composite material 100, such as before, after, or in lieu of lamination by film.

The shaping stage 929 can cut the composite material 100 into smaller pieces or shapes. For example and without limitation, the shaping stage 929 can comprise an in-line sheet cutter, which can cut the composite material 100 into smaller sheets 931. The sheets 931 can ultimately be converted into other products, such as A-B, or C-shaped, insulation liners, boxes, bags, panels, boards, and other finished or semi-finished products. A sheet stacker 930 can stack the sheets 931 as they come off of the manufacturing line. In some aspects, the shaping stage 929 can shape the composite material 100 into finished pieces. For example and without limitation, the composite material 100 can be cut to finished lengths and widths to produce smaller finished pieces, rather than producing larger sheets and converting them to finished pieces in a separate operation.

One should note that conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more particular embodiments or that one or more particular embodiments necessarily include logic for deciding, with or without user input or prompting, whether these features, elements and/or steps are included or are to be performed in any particular embodiment.

It should be emphasized that the above-described embodiments are merely possible examples of implementations, merely set forth for a clear understanding of the principles of the present disclosure. Any process descriptions or blocks in flow diagrams should be understood as representing modules, segments, or portions of code which include one or more executable instructions for implementing specific logical functions or steps in the process, and alternate implementations are included in which functions may not be included or executed at all, may be executed out of order from that shown or discussed, including substantially concurrently or in reverse order, depending on the functionality involved, as would be understood by those reasonably skilled in the art of the present disclosure. Many variations and modifications may be made to the above-described embodiment(s) without departing substantially from the spirit and principles of the present disclosure. Further, the scope of the present disclosure is intended to cover any and all combinations and sub-combinations of all elements, features, and aspects discussed above. All such modifications and variations are intended to be included herein within the scope of the present disclosure, and all possible claims to individual aspects or combinations of elements or steps are intended to be supported by the present disclosure.

That which is claimed is:

1. A method comprising:
mixing a plurality of ingredients to form a pre-foam mixture;
foaming the pre-foam mixture to produce a water-based foam;
mixing the water-based foam with cellulose fiber to form a composite material; and
curing the composite material to define a maximum pore diameter of about 3 mm.

2. The method of claim 1, further comprising drying the composite material after curing the composite material.

3. The method of claim 1, further comprising laminating the composite material with a film.

4. The method of claim 3, further comprising shaping the composite material before laminating the composite material.

5. The method of claim 3, further comprising shaping the composite material after laminating the composite material.

6. The method of claim 1, further comprising shaping the composite material.

7. The method of claim 6, wherein shaping the composite material comprises depositing the composite material in a mold.

8. The method of claim 6, wherein shaping the composite material occurs prior to curing the composite material.

9. The method of claim 6, wherein curing the composite material occurs prior to shaping the composite material.

10. The method of claim 6, wherein shaping the composite material and curing the composite material occur simultaneously.

11. The method of claim 6, wherein shaping the composite material comprises cutting the composite material into sheets.

12. The method of claim 1, wherein the plurality of ingredients comprises polyvinyl acetate, sodium coco sulfate, and hydroxypropyl methyl cellulose.

13. The method of claim 1, wherein the plurality of ingredients comprises starch, liquid egg whites, polyvinyl acetate, baking soda, and citric acid.

14. The method of claim 1, wherein a density of the pre-foam mixture is 13-14 times greater than the density of the water-based foam prior to curing.

15. A composite comprising:
cellulose fiber; and
a water-based foam binding the cellulose fiber, wherein the water-based foam defines a maximum pore diameter of about 3 mm.

16. The composite of claim 15, wherein the water-based foam defines an average pore diameter of about 1-2 mm and the composite is formed into an insulation batt.

17. The composite of claim 15, wherein the water-based foam comprises at least one of the group consisting of: polyvinyl acetate, sodium coco sulfate, and hydroxypropyl methyl cellulose.

18. The composite of claim 15, wherein the water-based foam comprises starch, liquid egg whites, polyvinyl acetate, baking soda, and citric acid.

19. The composite of claim 15, wherein the cellulose fiber comprises edge trim, and a length of each cellulose fiber exceeds one foot (12 inches) in length.

20. The composite of claim 15, further comprising a laminated coating that encapsulates the composite material.
